(19) United States
(12) Patent Application Publication
(10) Pub. No.: US 2007/0250459 A1
(43) Pub. Date: Oct. 25, 2007

(54) Method and system for conducting background investigations

(75) Inventors: Ken Schwarz, Vienna, VA (US); Chris Andrews, Richmond, VA (US)

Correspondence Address: VENABLE LLP, P.O. BOX 34385, WASHINGTON, DC, 20043-9998, US

(73) Assignee: Intersections, Inc., Chantilly, VA (US)

(21) Appl. No.: 11/714,914

(22) Filed: Mar. 7, 2007

Related U.S. Application Data
(60) Provisional application No. 60/779,447, filed on Mar. 7, 2006.

(51) Int. Cl. G06F 17/00

(52) U.S. Cl. 705/500

(57) ABSTRACT

A system for conducting background investigations is provided. The system present may a user interface to a user. A request for a service may be received via the user interface. The request for a service may include a request that a background investigation be performed on an individual. Initial information regarding a target of the investigation may be received. Based on the initial information, an identity of the target may be verified. If the identity of the target is verified, the investigation may be performed.

### BACKGROUND OF THE INVENTION

Background screening is one of the most reliable indicators when it comes to determining the attitude and character of potential employees. While background checks cannot predict with any particular degree of accuracy the job that any given employee will do, these reports can be used as integral parts of the hiring process. The range of information found in these reports can be extraordinarily valuable.

Background screening can tell an employer about serious incidents in the life of a job applicant. Crime reports and drug screening provide employers with the opportunity to minimize risks when hiring. It's important for employers to know which potential employees have erratic histories with the law or with drugs when choosing among candidates.

Background checks can also point out more subtle attributes. A person who has a history of moving rapidly from place to place may be less suited to a long-term position than a person who has shown more of a commitment to previous employers. Such factors can make the difference between a bad hire and a great one.

However, there are problems with current systems for performing background investigations. The background investigation is only as reliable as the initial information an individual provides about themselves. A applicant may not provide their real name and personal information when applying for a position. In addition to supplying false information, the applicant may use the real name and personal information of another individual whom the applicant believes can pass a background check. This is more likely to happen when the applicant has something to hide, increasing the risk associated with hiring them.

Accordingly, when a background check is performed using the fraudulent name, no information regarding the actual individual applying for the position is uncovered. Therefore, any relevant information such as criminal convictions, etc. regarding the actual individual applying for the position remains unknown. A similar problem has recently received a lot of attention in the media with criminals using fraudulent identities to obtain individuals' personal information from data aggregators and subsequently stealing the individuals' identities.

### SUMMARY OF THE INVENTION

Embodiments of the invention provide a method for authenticating identity, comprising receiving a request for an investigation on a target from a requesting entity; verifying an identity of the target before performing the investigation; and verifying an identity of the requesting entity before performing the investigation.

In a further embodiment of the invention a system for conducting background investigations is provided. The system present may a user interface to a user. A request for a service may be received via the user interface. The request for a service may include a request that a background investigation be performed on an individual. Initial information regarding a target of the investigation may be received. Based on the initial information, an identity of the target may be verified. If the identity of the target is verified, the investigation may be performed.

In a further embodiment of the invention, a case management system may be provided. The case management system may track and update the status of investigations. The case management system may also maintain accounts for users.

### BRIEF DESCRIPTION OF THE DRAWINGS

The foregoing and other features and advantages will be apparent from the following, more particular description of a preferred embodiment of the invention, as illustrated in the accompanying drawings, in which:

FIG. 1 depicts a process flow according to an exemplary embodiment of the present invention;

FIG. 2 depicts a process flow according to another exemplary embodiment of the present invention; and

FIG. 3 depicts an example of a system according to an exemplary embodiment of the present invention.

### DETAILED DESCRIPTION OF EMBODIMENTS OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention.

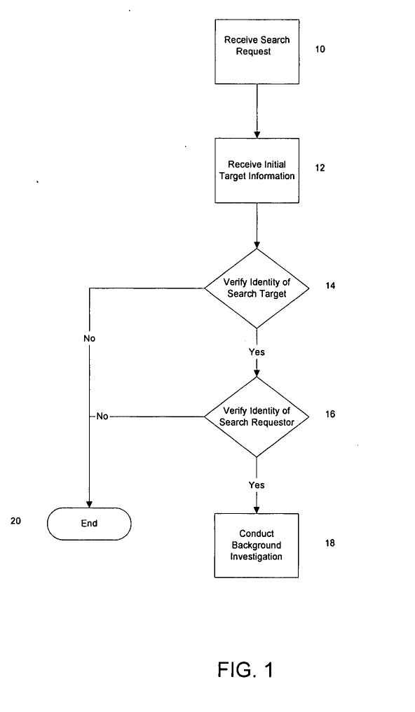

In an exemplary embodiment of the invention, a method and system for conducting background investigations is provided. FIG. 1 illustrates an overview of a process according to an embodiment of the invention. A background investigation may be initiated at the request of an entity, the search requestor. The search requestor may request that a background investigation be conducted on an individual, the search target. The request for a background investigation may be received by an entity whose business it is to conduct background investigations, a search entity, step 10. The search requestor may provide some basic identifying information regarding the search target to the search entity, step 12. The basic identifying information may include at least one of a name, address, telephone number, etc. This information is typically provided to the search requestor by the search target, for example, on an employment application and may not have been independently verified by the search requestor. The search target may also provide information used in the verification process.

Before an extensive background investigation is performed on the search target, the identity of the search target may be verified per step 14. That is, it may be checked that the search target is who they represent themselves to be. The search target's identity may be verified by requesting various information from the search target and then verifying the accuracy of that information. For example, co-pending U.S. patent application Ser. No. 11/515,385 describes a method and system for confirming personal identity. Information gathered from the search requester, search target as well as data from public and proprietary sources, such as databases may be used to verify the identity of the search target.

Gathered information may include basic “in-wallet” information. The “in-wallet” information may include the search target's name, address, driver's license number, credit card numbers with expiration dates, and other information typically found in a wallet. Out-of-wallet information may also be gathered. Out-of-wallet information, as the name suggests, may include information that is not typically found in a search target's wallet. Such out-of-wallet information may include the name of the search target's neighbors, a previous address, the high school the search target graduated from, who their neighbors currently are, etc. The out-of-wallet information gathered from the search target can vary greatly. Additionally, different questions may be asked of different search targets so that it is more difficult for someone to misrepresent themselves as someone else. The specific type of information gathered about an search target may also depend on the specific relationship or transaction being contemplated and the information available about an search target.

Information may be obtained from the search target by posing questions to elicit the information. The search target's authorization to allow the background search to be conducted may also be obtained during the verification process.

The questions may be posed via an interface on a website, via the telephone, in person, via e-mail, etc. The information that the search target provides in response to the questions are verified to ensure that the search target is who they claim to be. In fact, verification data regarding the search target may be obtained upon receipt of the basic identifying information, prior to the questions being posed to the search target. The answers and information provided by the search target may be compared to the verification data.

Various data sources may be mined to obtain the verification data. Multiple data sources may be checked to obtain the same verification data. Checking multiple data sources confirms the accuracy of the verification data. It may be preferable that the different data points be independent from each other.

The data sources may be mined to obtain specific verification data, such as answers to in-wallet and out-of-wallet questions, or general information. For example, the data sources may be mined specifically to obtain the search target's previous address, high school, and mother's maiden name. However, it may be that only the mother's maiden name and previous address are obtained by the data mining process. As the search target's high school was not obtained and therefore may be not verifiable, the search target may be not asked for that information. Instead, the search target may be questioned regarding their mother's maiden name and previous address. It may be preferable that the answers to the questions are known before the questions are posed to the search target.

Based at least in part on the search target's answers to the questions and verification of the answers, a verification score may be generated. The questions and answers may be weighted. For example, more difficult questions may carry more weight that easy questions. The verification score may be determined based on what questions were asked, how hard the questions are, how many questions the search target provided the correct answer for, etc. The verification score may be a pass/fail grade, a numerical rank, and the like.

Other identity verification methods, such as, for example, the eIDverify process available from Equifax may also be used. If the search target identity is not verified, the background investigation may end, step 20. The search requestor could also decide to proceed with the background investigation or pursue another course of action. The search requestor may be informed that the search target's identity could not be verified.

If the identity of the search target is verified, then the background search may continue. In a further embodiment of the present invention, the identity of the search requestor may also be verified, step 16. In such an embodiment, only individuals may be permitted to make search requests. Search requests from companies may be made in the name of a personnel manager or other individual. It is typically easier to verify the identity of individuals than it is to verify small businesses and other organizations. The verification of the identity of the search requester may be an initial step in the background investigation process. If the identity of the search requestor is not verified, the background investigation may be terminated per step 20. Otherwise the background investigation may proceed and the results provided to the search requestor.

Accordingly, embodiments of the invention provide a closed loop system for conducting background investigations. Verification of individual's identities may be performed at both ends of the background investigation, both on the requesting side and on the target side. As such, problems associated with fraudulent entities requesting personal information may be avoided.

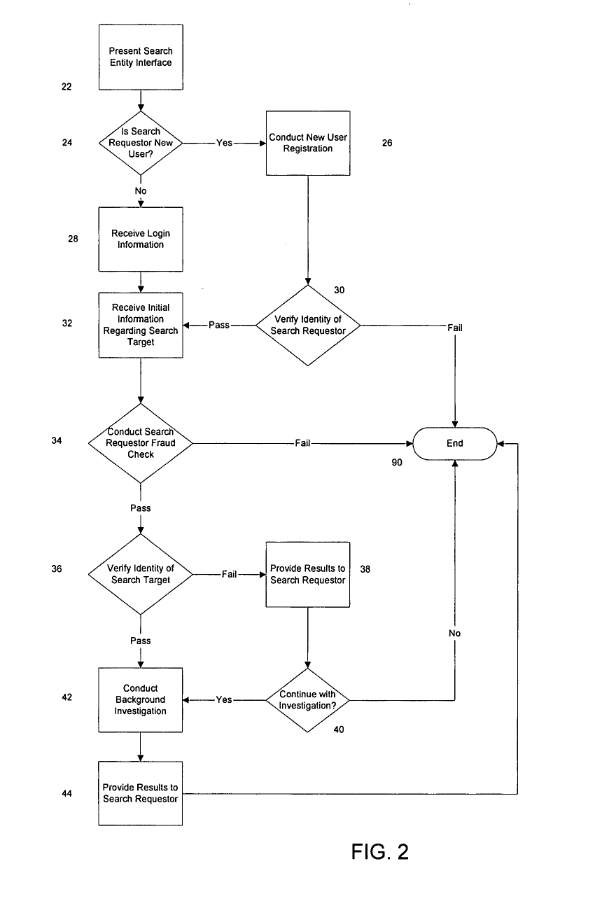

Referring now to FIG. 2, a method according to another exemplary embodiment of the invention is described. A search requestor may desire that a background investigation be performed on a search target. The search requester may be, for example, a little league, PTA, small business, etc. The search requestor may want to hire an individual, for example as a little league coach, and may want to verify that individual's identity and background. The search requestor may contact the search entity to request a background investigation. The search entity system may include a computer system and software programs. The search entity system may be accessed, for example, via an Internet web page.

Upon accessing the web page, the system may present a log in or registration page, step 22. A new or first time user may be required to register with the system before requesting a background investigation or other service, steps 24-26. As part of the registration process, the search requestor may be required to provide individual information, such as their name, residence address, company name if applicable, and the like. The registration process may establish an account for the search requestor. The search requester may then select a user name and password that provides access to the system and their account. If a search requestor is already registered, the appropriate user name and password may be used to log in and access the system, step 28. Once registered and/or logged in, the user may request a background investigation be conducted, check the status of previously requested background investigations or other information regarding their account.

During the registration process, the identity of the search requestor may be verified, step 30. If the identity of the search requester cannot be verified, the process may end, step 90. The identity verification may be done by posing a series of questions to the search requester and then gauging the accuracy of the responses from the requestor in a similar manner as described above for verifying the identity of the search target. The questions posed to the search requestor may be based on information obtained from public records regarding the search requestor. For example, the search requester may be asked to verify their drivers license information, home address, telephone number, social security number, prior addresses, and the like. The accuracy of the search requestor's responses may be used to verify the identity of the search requester. Personal information received may be from the search requestor during the registration process. This personal information may be used to obtain additional information regarding the search requestor, which additional information may then used to verify the identity of the search requestor. Preferably, the identity verification is some type of automated identity verification process. For example, the elDverify process available from Equifax or a similar procedure may be used for identity verification.

One of the options presented to the search requestor may be to request a background investigation. This process may be initiated by selecting the appropriate button or option on the web page. A request for information regarding the search target may be given to the search requestor, step 32. Typically the search requestor has some contact information for the search target, for example, information received on ajob application. Text boxes may be provided for entering, for example, the search target's phone number, e-mail address, facsimile number, physical address, or other information that the search requestor may have regarding the search target. Once the search target information is entered, the search requestor may click a finish button and submit the information. The search requester may then exit the system or request another function.

In order to prevent abuse of the system, the number of searches that an individual may request and the time frame in which those searches are requested may be monitored, step 34. For example, an individual may be permitted ten background investigation over a two month period of time. When an individual makes a search request, the individual's account may be checked to see if the number of allocated searches has been exceeded and to add the current request to their tally. If the system detects that an individual is making an excessive number of search request, this may indicate fraudulent use of the system and the individual's account may be, for example, terminated, flagged for follow-up and investigation and/or the investigation process terminated, step 90.

Once the search request is approved and the search target information is submitted and received by the system, the search target information is processed. In step 36, the identity of the search target may be verified. In an example verification, the search target may be contacted, for example, using contact information provided by the search requestor. Contact with the search target may take place via e-mail, telephone, etc. The search target may be informed that a background investigation has been requested for them. The identity of the search requestor may be provided to the search target. The search requestor may be given the option for releasing their identity to the search target. The search target may be requested to consent to the search and to release the search entity to provide information uncovered by the search to the search requestor.

When the search target is contacted, the search target may be provided information in order to communicate with the search entity. For example, the search target may be sent an e-mail, informing them of the background investigation. The e-mail may include a user name and password. For example, a user name and password to log into the system may be provided to the search target. Once the search target is logged in, questions may be posed to the search target to verify their identity, for example, in the manner as described above. The search target may be contacted via letter, facsimile, telephone or other communication channel. The search target may also be given a telephone number to call, an office location to visit, etc. The questions may be posed to the search target via the telephone, in person, and the like.

For a variety of reasons, the system may not receive a response from the search target. For example, the contact information for the search target may be inaccurate or the search target may simply ignore the attempts to contact them. There are several options if there is no response to the attempt at contacting the search target. For example, the search entity may attempt to contact the search target via different means, for example, via telephone, facsimile, or letter if an e-mail contact attempt is unsuccessful. Also, or if no other contact information for the search target is available, the search requestor may be contacted for additional information regarding the search target. The search requestor may be informed that no response was received from the search target in response to search request.

Even if a response is received from the search target, the search target may not authorize the background investigation. The search requestor may informed of the search target's refusal to authorize the search, failure of the identity verification and/or unsuccessful contact attempts, step 38. The search requestor may decide to end the background search process, steps 40, 90. Otherwise, the search continues per steps 42 and 44 with the results being presented to the search requestor.

In further embodiments of the invention, information from the search target may be used to verify the identity of the search requester. For example, the search target may be contacted and informed that the search requestor is requesting a background investigation on the search target. The search target may be asked if they know the search requester. If the search target responds in the affirmative, this information may be used to verify the identity of the search requestor. Presumably, the search target knows the search requestor, and would not authorize a search by someone they do not know. Additionally, if the search target authorizes the release of information to the search requester and the identity of the search target is verified, this may further verify the identity of the search requestor.

A background investigation may include a check of at least one of an individual's employment or criminal record. There may be different levels of background investigation offered, for example, varying in the depth of investigation, resources checked or information included in the report. The background investigation may be carried out using systems and methods that are well known to those of ordinary skill of the art. The search entity may gather and format the search results and provide the results to the search requestor. For example, the search requestor may be sent alerts when various steps in the search process and when the search itself is completed, as is described in more detail below. The search requester may log into their account to view the search results or the search results may be sent to them.

A system according to the present invention may include a case management system. The case management system may be embodied as a software program stored on a computer readable medium and executed by a computer. The case management system may track the status of background searches and manage accounts. The status of searches may be updated as the various steps of a search are conducted. The search requester may access the case management system and track the status of their pending searches.

Referring back to FIG. 2, the search requestor, upon log in or registration, may be presented with an option to check the status of their searches. Upon selecting this option, the search requestor may be presented with a screen showing the pending and/or completed searches for that search requester. The search requestor may then select one of these searches to obtain more detailed information regarding the search, for example, by clicking on a particular search. The case management system may then provide the status of the search or the search results to the search requestor via the web interface.

The case management system may update the search progress at various times during performance of the search. For example, the status of the search may be updated when contact is attempted with the search target, when contact is made with the search target, when the search target responds to the contact, when the identity of the search target is verified, and at other steps in the background search process.

The case management system may also track and maintain the account of the search requestor. The case management system may be responsible for implementing security features to prevent abuse of the background search system, mentioned above. For example, the case management system may track the number of search requests made by a particular individual, how often a particular individual makes search request and the like. This information may be monitored to prevent abuse or fraudulent use of the background investigation system. The case management system may also track and bill a search requester for services provided. an account module for establishing an account for a search requestor, the account a listing of including pending and completed background investigation and status; and

The case management system may include an account module for establishing an account for a search requestor. The account may include a listing of including pending and completed background investigation and status, as well as billing information. A verification module for receiving a request for verification of target from the search requester may also be provided. The request includes information that can identify the target and for performing a verification process for the target's identity based at least on the information in the request.

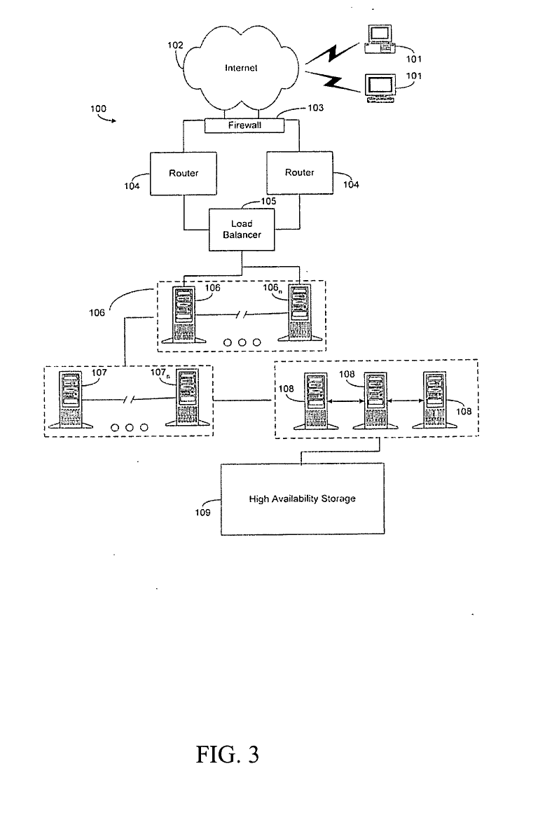

Turning now to FIG. 3, a schematic diagram of an exemplary system 100 that provides personal identity validation and confirmation according to an embodiment the present invention is shown. System 100 is intended to be accessed by a plurality of clients 101. Such clients 101, in turn, suitably comprise one or more computers and workstations. It should be understood, nevertheless, that other clients 101 such as Web-enabled hand-held devices (e.g., the Palm V™ organizer manufactured by Palm, Inc., Santa Clara, Calif. U.S.A., Windows CE devices, and “smart” phones) which use the wireless access protocol, and Internet appliances fall within the spirit and scope of the present invention. Clients 101 may be used by search targets and search requestors to interact with the search entity.

Clients 101 of all types suitably access system 100 by way of the Internet 102. By use of the term “Internet”, it should be understood that the foregoing is not intended to limit the present invention to a network also known as the World Wide Web. For example, it includes intranets, extranets, Virtual Private Networks (VPNs), and the like. Clients are directed to the service provider's web servers 106₁, 106₂, . . . 106ₙ through firewall 103, routers and proxy servers 104 and load balancer 105.

System 100 further comprises a plurality of application servers 107₁, 107₂, . . . 107ₙ, coupled to and providing support to the web servers 106₁, 106₂, . . . 106ₙ. In addition to supporting the Web servers the application servers support the verification processing and other back office (batch) processing. High availability storage 109 for the database 108 is also provided and preferably is a Raid Shared Storage.

The various modules may be deployed as software running on the system described above. Various portions of the software may be distributed on different computers and still achieve the same functionality.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. For example, the order in which the steps are performed may be varied as long as the above-described dependencies are maintained. It is therefore to be understood that, within the scope of the claims and their equivalents, the invention may be practiced otherwise than as specifically described.

We claim:

1. A method for authenticating identity, comprising:
receiving a request for a background investigation on a target individual from a requester;
verifying an identity of the target individual before performing the investigation; and
verifying an identity of the requestor before performing the background investigation.

2. The method of claim 1, further comprising causing the background investigation to be performed.

3. The method of claim 1, wherein verifying the identity of the target individual further comprises:
receiving initial information regarding the target individual from the requestor at a time of the request; and
verifying the identity of the target individual based in part on the initial information.

4. The method of claim 2, further comprising:
tracking a number of requests made by the requestor over a predetermined period of time; and
performing the background investigation only if a number of requests is below a predetermined limit.

5. The method of claim 1, wherein the requestor is an individual.

6. The method of claim 3, wherein the initial information comprises one of name, address, telephone number or social security number.

7. The method of claim 3, further comprising receiving at least some of the initial information from the search target.

8. A method, comprising:
receiving a request from a requestor for a background investigation on a target;
receiving initial information regarding the target from the requester;
verifying an identity of the target based at least on the initial information; and
conducting the background investigation if the identity of the target is verified.

9. The method of claim 8, further comprising:
receiving personal information regarding the requestor; and
verifying an identity of the requestor based on the personal information before conducting the background investigation.

10. The method of claim 8, wherein verifying the identity of the target further comprises:
sending a communication to the target;
receiving additional information from the target; and
verifying the identity of the target based at least on the additional information.

11. The method of claim 10, wherein the additional information includes one of in-wallet and out of wallet information.

12. The method of claim 10, further comprising:
contacting the target regarding the background investigation; and
informing the requestor if the target does not respond to the contact.

13. The method of claim 12, further comprising attempting contact via a different communication channel.

14. The method of claim 9, further comprising:
receiving information regarding the requestor from the target; and
verifying the identity of the requestor based in part on the information from the target.

15. The method of claim 8, further comprising providing alerts to the requestor at selected points of the background investigation.

16. A case management tool for managing background investigations, comprising:
an account module for establishing an account for a search requester, the account a listing of including pending and completed background investigation and status; and
a verification module for receiving a request for verification of target from the search requester, wherein the request includes information that can identify the target and for performing a verification process for the target's identity based at least on the information in the request.

17. The case management tool of claim 16, wherein the account module performs the following steps:
receiving log-in and password information for the requester;
verifying the log-in and password;
and providing access to a corresponding account based on the verifying step.

18. The case management tool of claim 16, wherein the account module communicates with the verification module to obtain background investigation status.

19. The case management tool of claim 16, wherein the verification module tracks the status of background investigations and sends alerts to the requestor at predetermined benchmarks.

20. The case management tool of claim 16, wherein the verification module verifies an identity of the requestor.

21. The case management tool of claim 16, wherein the account module tracks search requests from a requester over a predetermined time and disallows further search requests when the requests exceeds a predetermined amount.
